(19) United States
(12) Patent Application Publication
(10) Pub. No.: US 2010/0006734 A1
(43) Pub. Date: Jan. 14, 2010

(54) Material support apparatus

(76) Inventor: Will D. Connell, Callaway, NE (US)

Correspondence Address: SUITER SWANTZ PC LLO, 14301 FNB PARKWAY, SUITE 220, OMAHA, NE, 68154, US

(21) Appl. No.: 12/217,848

(22) Filed: Jul. 9, 2008

(51) Int. Cl. F16M 11/00

(52) U.S. Cl. 248/440

(57) ABSTRACT

A beam support assembly and a material support assembly are presented.

A beam support assembly may comprise a frame portion defining a beam receiving aperture wherein the frame portion defining the beam receiving aperture is configured to contact a beam disposed within the beam receiving aperture when the frame portion is positioned in an at least partially non-vertical orientation.

A material support apparatus may comprise at least one beam support assembly including a frame portion defining at least one beam receiving aperture and at least one substantially rigid beam member, wherein the frame portion defining the at least one beam receiving aperture is configured to contact the at least one substantially rigid beam member when the at least one substantially rigid beam member is disposed within the beam receiving aperture and the frame portion is positioned in an at least partially non-vertical orientation.

### BACKGROUND

Numerous material supports are known. One type of material support used in construction is commonly known as a sawhorse. In the past, reusable sawhorses have been bulky and difficult to transfer from one job to another. As such, temporary sawhorses have often been constructed on site.

As such a need exists for a simple, sturdy, portable materials support apparatus.

### SUMMARY

A beam support assembly and a material support assembly are presented.

A beam support assembly may comprise a frame portion defining a beam receiving aperture wherein the frame portion defining the beam receiving aperture is configured to contact a beam disposed within the beam receiving aperture when the frame portion is positioned in an at least partially non-vertical orientation.

A material support apparatus may comprise at least one beam support assembly including a frame portion defining at least one beam receiving aperture and at least one substantially rigid beam member, wherein the frame portion defining the at least one beam receiving aperture is configured to contact the at least one substantially rigid beam member when the at least one substantially rigid beam member is disposed within the beam receiving aperture and the frame portion is positioned in an at least partially non-vertical orientation.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is an isometric view of a material support apparatus.

FIG. 2 is an isometric view of a support member.

FIG. 3 is a cross-sectional view of a material support apparatus.

FIG. 4A is a cross-sectional view of a support member.

FIG. 4B is a cross-sectional view of a support member.

FIG. 4C is a cross-sectional view of a support member.

FIG. 5 is an isometric view of a support member.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

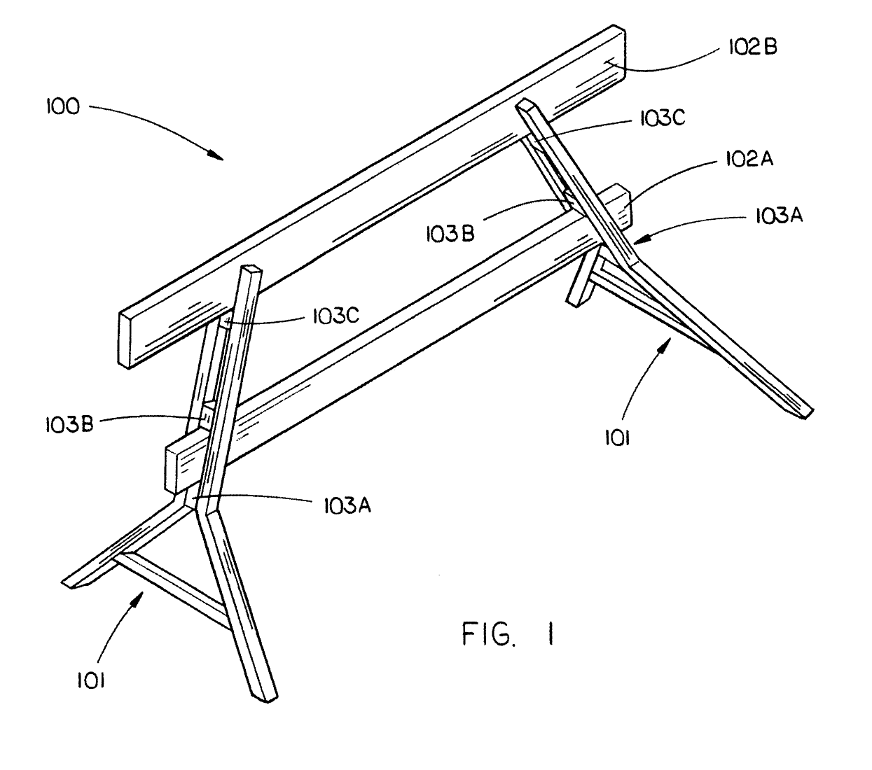

Referring to FIG. 1, a material support apparatus 100 is shown. The material support apparatus 100 may comprise at least one beam support assembly 101 coupled with at least one horizontal beam member 102. The at least one horizontal beam member 102 may be supported by at least one cross-member portion 103 of at least one of the beam support assembly 101.

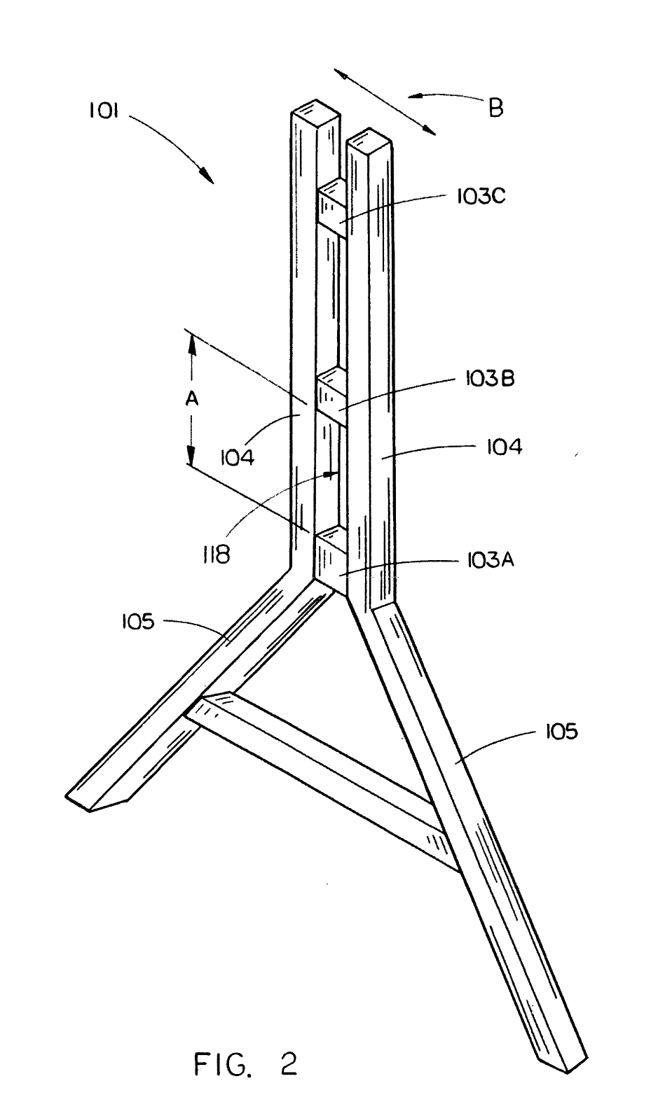

Referring to FIG. 2, a beam support assembly 101 is shown. The beam support assembly 101 may comprise at least one frame member 104. Two or more cross-member portions 103 (e.g. cross-member portion 103A and cross-member portion 103B) may be operably coupled to the frame member 104 so as to define a beam receiving aperture 118. The beam receiving aperture 118 defined by the frame member 104, cross-member portion 103A and cross-member portion 103B may such that the dimension A is slightly larger than a standard width dimension of a common cut of lumber (e.g. a dimension A of 3.75 inches may be associated with a standard 2×4 width dimension of 3.5 inches) as will be discussed below. At least one secondary cross-member portion 103C may be operably coupled to the frame member 104 at a position above and/or below the cross-member portion 103A and cross-member portion 103B.

The beam support assembly 101 may further comprise at least one support leg portion 105. The support leg portion 105 may be configured at an angle (e.g. 120°) with respect to a frame member 104. Such a configuration may provide a degree of lateral support in a direction B for the frame member 104 when disposed in a substantially upright position.

It will be recognized by one skilled in the art any number of cross-member portions 103 may be employed without departing from the scope of these disclosures.

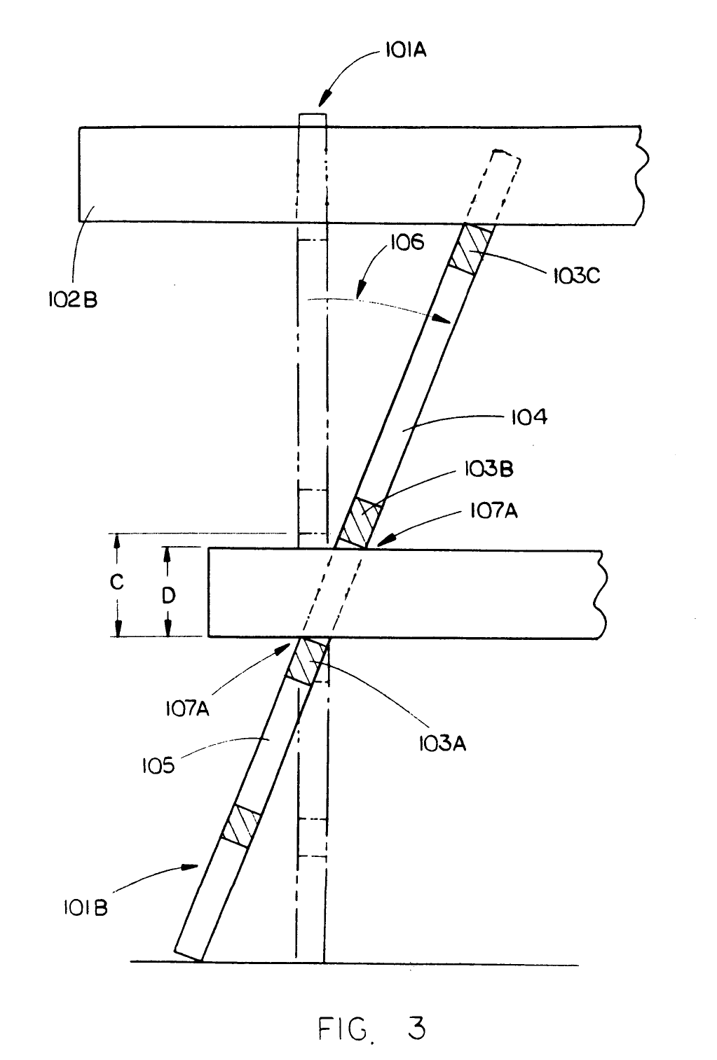

Referring to FIG. 3, cross-sectional representations of various operational configurations of a beam support assembly 101 are shown. In a first configuration, a beam support assembly 101 may be disposed in a substantially vertical position (e.g. beam support assembly 101A) in relation to a horizontal beam member 102A disposed in a substantially horizontal position. As previously referenced above, the cross-member portion 103A and cross-member portion 103B may have a spatial separation C greater than the height D of horizontal beam member 102A. Due to such dimensioning, at most, only one cross-member portion 103 may contact the horizontal beam member 102A at a given time when the beam support assembly 101 is in a substantially vertical position (e.g. beam support assembly 101A) in relation to a horizontal beam member 102A.

In a second configuration, the beam support assembly 101 may be disposed in a position which is rotated by an angle 106 away from a substantially vertical position (e.g. beam support assembly 101B) while the horizontal beam member 102A is maintained in a substantially horizontal position. The angle 106 may be defined by the relative spacing of cross-member portion 103A and cross-member portion 103B. The beam support assembly 101B may be rotated until a contact point 107A of the cross-member portion 103A and contact point 107B of cross-member portion 103B contact the horizontal beam member 102A. Rotational action of the beam support assembly 101B due to gravity may cause cross-member portion 103A and cross-member portion 103B to exert a moment force on the horizontal beam member 102A which may be directly opposed by an opposite moment force provided by a second beam support assembly 101B in a similar rotated configuration (as shown in FIG. 1) or any other support structure supporting an opposite end of the horizontal beam member 102A. Such mutual moment forces may operate to secure the horizontal beam member 102A in a fixed position.

When the at least one beam support assembly 101 has been secured in its fixed position through its rotation by angle 106 (e.g. until contact point 107A and contact point 107B have each contacted horizontal beam member 102A), cross-member portion 103C may then be used to support a second horizontal beam member 102B. The cross-member portion 103C may be positioned relative to the frame member 104 such that the cross-member portion 103C and the frame member 104 form a beam receiving channel 119 so as to receive and secure horizontal beam member 102B.

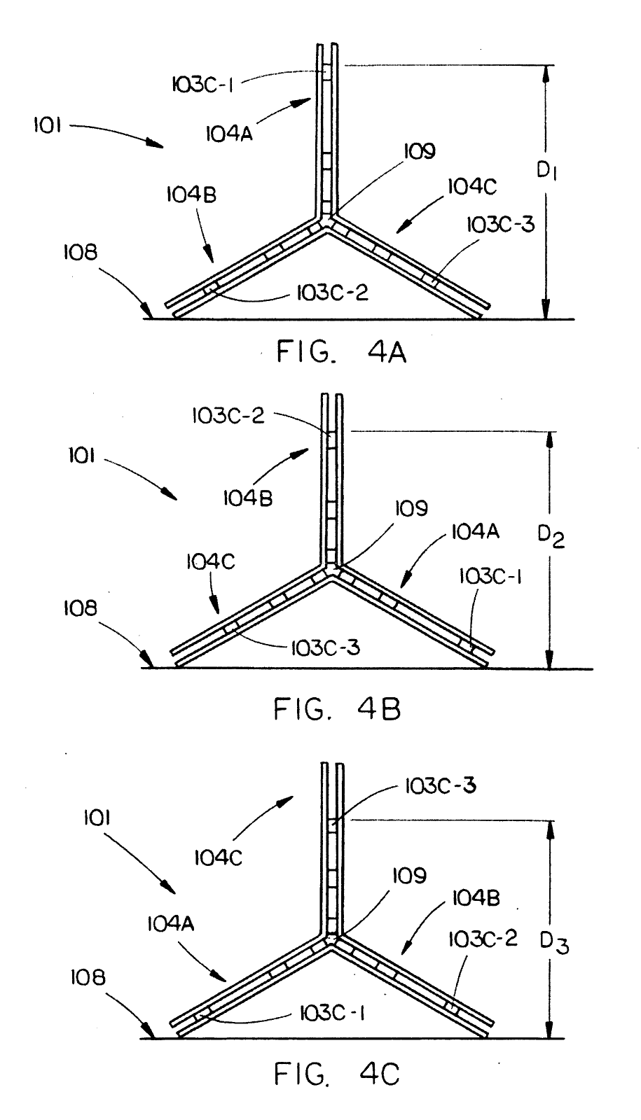

Referring to FIGS. 4A-4C, an alternate embodiment of a beam support assembly 101 is shown. The beam support assembly 101 may include at least two frame members 104. Particularly, frame member 104A, frame member 104B and frame member 104C may each be disposed in angled configurations with respect to the another the other frame members (e.g. 120°) such that when any two of the frame members 104 are disposed on an underlying surface 108, the third frame member 104 may be positioned in a substantially vertical manner.

Each of frame member 104A, frame member 104B and frame member 104C may comprise cross-member portions 103 having varying relative distances to a center point 109 of the beam support assembly 101. For example, as shown in FIG. 4A, when frame member 104B and frame member 104C are positioned on the underlying surface 108, cross-member portion 103C-1 of frame member 104A may be configured such that it has a top surface which is a distance D1 from the underlying surface 108. Similarly, as shown in FIG. 4B, when frame member 104A and frame member 104C are positioned on the underlying surface 108, cross-member portion 103C-2 of frame member 104B may be configured such that it has a top surface which is a distance D2 from the underlying surface 108. Finally, as shown in FIG. 4C, when frame member 104A and frame member 104B are positioned on the underlying surface 108, cross-member portion 103C-3 of frame member 104C may be configured such that it has a top surface which is a distance D3 from the underlying surface 108. As such a single beam support assembly 101 may provide support for horizontal beam member 102B at multiple heights.

It will be recognized by one skilled in the art that the practice of varying the distance of cross-member portions 103 from the center point 109 as shown in FIGS. 4A-4C may be applied to cross-member portion 103A and cross-member portion 103B as well so as to provide support for horizontal beam member 102A at multiple heights with a single beam support assembly 101.

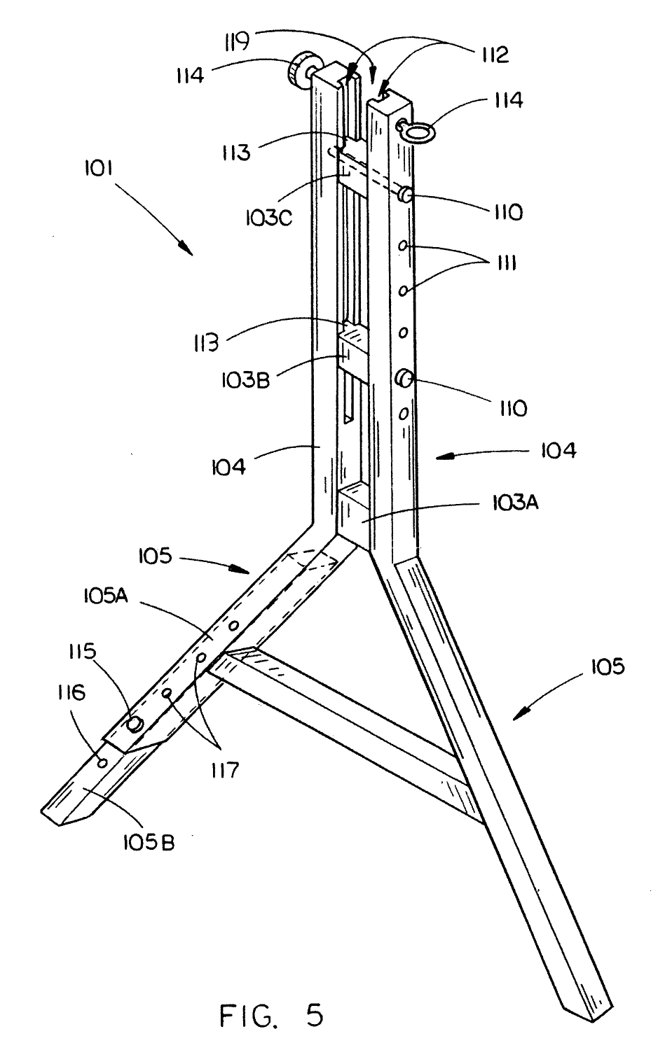

Referring to FIG. 5, an alternate embodiment of a beam support assembly 101 is shown. The beam support assembly 101 may be generally as pictured in FIGS. 1-3. The beam support assembly 101 may further comprise a mechanism for adjustably configuring at least one cross-member portion 103. For example, cross-member portion 103B and/or cross-member portion 103C may be translated vertically along the at least one frame member 104. The cross-member portion 103B and/or cross-member portion 103C may be affixed in a given position by a locking pin 110. The locking pin 110 may pass through cooperating apertures in the frame member 104 (e.g. aperture 111) and the cross-member portion 103B and/or cross-member portion 103C (not shown) so as to secure the cross-member portion 103B and/or cross-member portion 103C in position. The locking pin 110 may be a bolt having a threaded portion configured to cooperatively engage a threaded aperture 111. In a further embodiment, the locking pin may be secured by a cotter pin (not shown). The frame member 104 may also include a channel portion 112 configured to receive a projecting potion 113 of the cross-member portion 103B and/or cross-member portion 103C so as to further secure the cross-member portion 103B and/or cross-member portion 103C.

The beam support assembly 101 may further comprise a beam locking mechanism 114. The beam locking mechanism 114 may operate to secure horizontal beam member 102B in place when disposed atop cross-member portion 103C. For example, as shown in FIG. 5, the beam locking mechanism 114 may comprise at least one fastener knob 114. The fastener knob 114 may include a threaded portion configured to cooperatively engage a threaded aperture 111. The fastener knob 114 may be inserted to an extent where it contacts the horizontal beam member 102B, thereby securing the horizontal beam member 102B in position.

It will be recognized by one skilled in the art any type of beam locking mechanism 114 (e.g. spring-loaded clamps, straps, c-clamps, etc.) may be employed either in combination with or in place of cross-member portion 103C so as to secure the horizontal beam member 102B in position without departing from the scope of these disclosures.

In still further embodiments, a frame member 104 and/or support leg portion 105 may be configured to be extensible, thereby providing for additional height adjustments of the beam support assembly 101. For example, frame member 104 and/or support leg portion 105 may comprise an external sleeve portion 105A disposed about an internal extension portion 105B. The internal extension portion 105B may be extended or retracted so as to alter the height or increase the stability of the beam support assembly 101. The internal extension portion 105B may be affixed in a substantially static position by a locking pin 115 disposed through cooperating apertures in the internal extension portion 105B (e.g. aperture 116) and the external sleeve portion 105A (e.g. aperture 117). It will be recognized by one of skill in the art that the extension features (e.g. the internal extension portion 105B and the external sleeve portion 105A) described particularly with reference to support leg portion 105 may be similarly employed for frame member 104 to provide additional height to the beam support assembly 101.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

What is claimed is:

1. A beam support assembly comprising:
a frame portion defining a beam receiving aperture;
wherein the frame portion defining the beam receiving aperture is configured to contact a beam disposed within the beam receiving aperture when the frame portion is positioned in an at least partially non-vertical orientation.

2. The beam support assembly of claim 1, wherein the frame portion further comprises:
a first cross-member portion defining a first side of the beam receiving aperture; and
a second cross-member portion defining a second side of the beam receiving aperture,
wherein the first-cross member portion and second cross-member portion cooperatively contact a beam disposed within the beam receiving aperture when the frame portion is positioned in an at least partially non-vertical orientation.

3. The beam support assembly of claim 2, wherein the frame portion further comprises:
a third cross-member portion.

4. The beam support assembly of claim 3, wherein a position of at least one of the first cross-member portion the second-member portion, and the third cross-member portion is adjustable relative to the frame portion.

5. The beam support assembly of claim 1, further comprising:
a beam locking mechanism.

6. The beam support assembly of claim 1, further comprising:
a support leg portion.

7. The beam support assembly of claim 6, wherein at least one of the frame portion and the support leg portion is extensible.

8. A material support apparatus comprising:
at least one beam support assembly including a frame portion defining at least one beam receiving aperture;
at least one substantially rigid beam member;
wherein the frame portion defining the at least one beam receiving aperture is configured to contact the at least one substantially rigid beam member when the at least one substantially rigid beam member is disposed within the beam receiving aperture and the frame portion is positioned in an at least partially non-vertical orientation.

9. A beam support assembly comprising:
two or more frame members, each frame member defining at least one beam receiving aperture,
wherein a first frame member is disposed at an angle with respect to a second frame member,
wherein a beam receiving aperture of a first frame member is disposed at a first distance from a centroid of the beam support assembly, and
wherein a beam receiving aperture of a second frame member is disposed at a second distance from a centroid of the beam support assembly.
